(19) United States
(12) Patent Application Publication
(10) Pub. No.: US 2026/0235172 A1
(43) Pub. Date: Aug. 13, 2026

(54) PARKING BRAKE DEVICE INTEGRATED IN AN ELECTRIC MACHINE

(71) Applicant: AMPERE S.A.S., Boulogne Billancourt (FR)

(72) Inventor: Eric DUMAS, Guyancourt (FR)

(73) Assignee: AMPERE S.A.S., Boulogne Billancourt (FR)

(21) Appl. No.: 19/118,224

(22) PCT Filed: Oct. 5, 2023
(86) PCT No.: PCT/EP2023/077645

§ 371 Date: Apr. 23, 2025

(30) Foreign Application Priority Data
Oct. 6, 2022 (FR) FR2210245
Oct. 6, 2022 (FR) FR2210249

(51) Int. Cl. F16D 63/00; H02K 7/00; H02K 7/12

(52) U.S. Cl. CPC F16D 63/006; H02K 7/006; H02K 7/12

(57) ABSTRACT

A parking brake device is suitable for being installed in a casing of an electric machine that houses a rotary shaft and at least one rolling bearing for guiding the rotary shaft. The parking brake device includes an annular support suitable for being inserted between the rolling bearing and the casing. The annular support bears a parking brake mechanism to prevent the rotation of the rotary shaft relative to the casing, and a measurement device to measure the angular position or speed of the rotary shaft relative to the casing, and/or an electrical conduction device to route the electrical current between the rotary shaft and the casing.

### TECHNICAL FIELD OF THE INVENTION

The present invention relates in general to the braking of motor vehicles.

It relates more particularly to a device which has a parking brake function.

It also relates to an electric machine fitted with such a device and to a motor vehicle comprising such an electric machine.

### PRIOR ART

Various types of parking brake are known.

For example hand brakes comprising a handle that can exert a pull on a metal cable attached to a brake caliper designed to immobilize the rear wheels of the vehicle are known.

Also known are electric parking brakes that comprise an actuator, which in this case is also able to actuate cables attached to the brake calipers.

Although this second system uses less space than the first, it still proves to be bulky and also expensive.

Thus, document DE102017217829 discloses a device which is arranged differently and is usable on electric vehicles. In that document, the braking device comprises a pawl mechanism able to lock onto a toothed wheel fixed to the shaft of the electric motor of the vehicle. As a result, this device makes it possible to prevent the rotation of the shaft of the electric motor and, therefore, the rotation of the wheels of the vehicle.

In that document, the toothed wheel is fixed to the end of the shaft of the electric motor, against the drive pinion of the driven wheels.

However, this device is still bulky. It also does not make it possible to reduce the noise of the electric motor.

### PRESENTATION OF THE INVENTION

In order to overcome the aforementioned disadvantages of the prior art, the present invention proposes placing the parking brake as close to the motor as possible.

More particularly, the invention proposes a parking brake device suitable for being directly installed in an electric machine casing which receives a portion of at least one rotary shaft and at least one rolling bearing for guiding said rotary shaft.

According to the invention, this parking brake device comprises an annular support which is designed to be (radially) inserted between said rolling bearing and said casing and which bears:
a parking brake mechanism designed to prevent the rotation of the rotary shaft relative to the casing, and:
measurement means designed to measure the angular position or speed of the rotary shaft relative to the casing, and/or electrical conduction means designed to route the electrical current between the rotary shaft and the casing.

The annular nature of the support makes it possible to place this support around the rotary shaft of the electric machine, between the outer race of the rolling bearing and an opening formed in the casing.

In this way, the invention makes it possible for the elements borne by this annular support to be positioned in the casing of the electric machine, as close to the rotor as possible, in a space which up to now was left unoccupied. The device then proves to be not very bulky and can be installed in a protected and lubricated space, thereby ensuring it operates correctly, at lower cost and over the long term.

The advantage of placing the annular support between the casing and the rolling bearing is that this support can then reduce the running noise. If it is made from a suitable material, it can indeed have a stiffness greater than that of the casing, and this will reduce vibrations and therefore noise.

Typically, when this support is made from gray cast iron, it is able to damp acyclic behavior of the rotary shaft and ensure good lubrication around the rolling bearing when the latter is rotating at a very high speed and starts to “levitate”.

This support, when it is made of a suitable material, can moreover exhibit a coefficient of expansion closer to that of the rolling bearing than the casing, so that the clearance around the rolling bearing will be less sensitive to variations in temperature, and this will reduce the noise even more.

By reducing vibrations, this support will moreover make it possible to ensure that the electric machine as a whole has a longer service life.

It will lastly be noted that the advantage of placing this parking brake device as close to the rotor of the electric machine as possible, rather than close to the wheels of the vehicle, is that the braking torque needed to immobilize the vehicle will be lower than that needed if it was placed at the wheels. Specifically, this braking torque will be divided by the speed reduction ratio provided between the rotary shaft of the motor and the wheels. It is thus possible to use a brake device of smaller dimensions.

Another aspect of the invention is that the annular support bears components for providing various functions. This aspect has several advantages. The first is that it makes it possible to reduce the number of components of the electric machine since a single support bears several functions. The second is that it makes it possible to assemble these components outside of the electric machine, thereby making this assembly easier. The third is that all of the forces exerted on these components are taken up by the annular support, which is dimensioned solely on the basis of the component that generates the most force. The third is that this mounting makes it possible to ensure that the components are coaxial and thus that they operate correctly.

It will lastly be noted that the installation of this braking device in the casing involves installing a toothed wheel on the rotary shaft of the electric machine for providing the parking brake function. This toothed wheel will then advantageously make it possible to increase the stiffness of the shaft and thus make sure it does not deflect to an excessive extent.

Further advantageous and nonlimiting features of the device according to the invention, considered individually or in any technically possible combinations, are as follows:
the annular support bears measurement means and electrical conduction means;
said electrical conduction means are designed to be interposed between the rolling bearing and the measurement means;
the parking brake mechanism comprises a means for catching on a toothed wheel fixed to said rotary shaft, and an actuator designed to move the catching means between a position caught on the toothed wheel and a position not caught on the toothed wheel;
the electrical conduction means comprise a ring fixed to the annular support and flexible electrical conduction elements which press against a portion of the toothed wheel;
provided between the actuator and the catching means is an elastically deformable portion designed to allow the actuator to move when the catching means is immobilized by the toothed wheel;
the measurement means comprise a position sensor designed to determine the position of a washer fixed to the rotary shaft;
the annular support is formed of a single one-piece part and is preferably made at least partially from cast iron;
the annular support delimits an inner face of which a portion that is a cylinder of revolution receives said rolling bearing, and an outer face of which a portion that is a cylinder of revolution is designed to be installed in an opening in the casing.

The invention also provides an electric machine comprising a casing, a rotor received in the casing, a rotary shaft which is fixed to the rotor and is pivotably mounted in the casing by means of at least one rolling bearing, and a parking brake device as mentioned above.

In addition, the parking brake device of said machine may comprise a lever designed to rock about a rocker axis to prevent the rotation of the rotary shaft relative to the casing, the parking brake device
which is designed to be inserted between said rolling bearing and said casing,
which bears said lever, and
which is fixed to the casing by a fixing screw passing through said rocker axis.

It also relates to a motor vehicle comprising a chassis, wheels and an electric machine as mentioned above, of which the rotary shaft is coupled to at least some of said wheels.

Of course, the different features, variants and embodiments of the invention may be combined with one another, in various combinations, provided that they are not mutually incompatible or exclusive.

### DETAILED DESCRIPTION OF THE INVENTION

The description which follows with reference to the appended drawings, which are given by way of nonlimiting examples, will make it easy to understand what the invention consists of and how it can be achieved.

In the appended drawings:

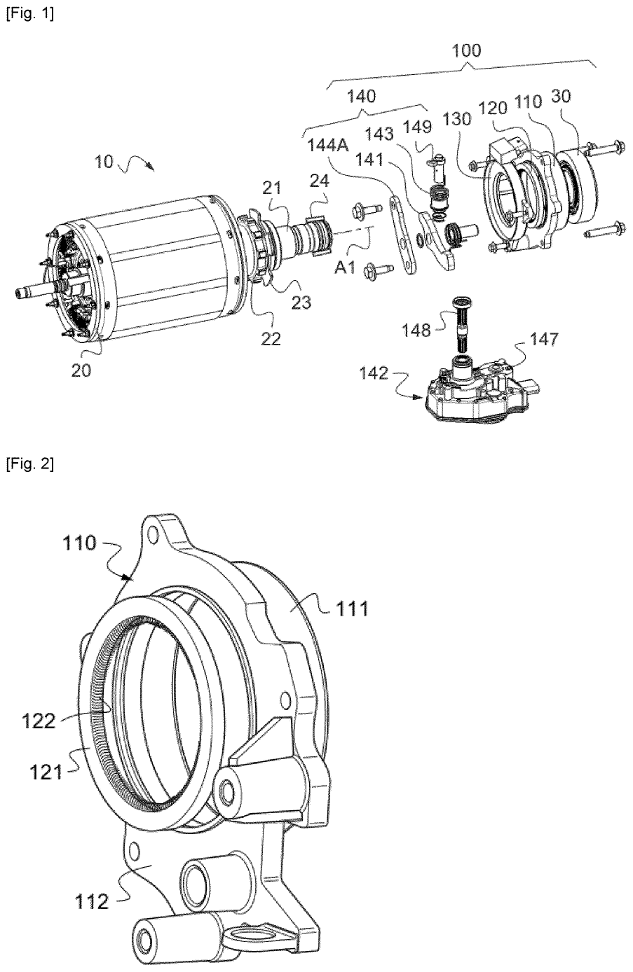

FIG. 1 is a schematic exploded view, in perspective, of a portion of an electric machine according to the invention;

FIG. 2 is a schematic view, in perspective, of the annular support and of the washer for grounding the electric machine in FIG. 1;

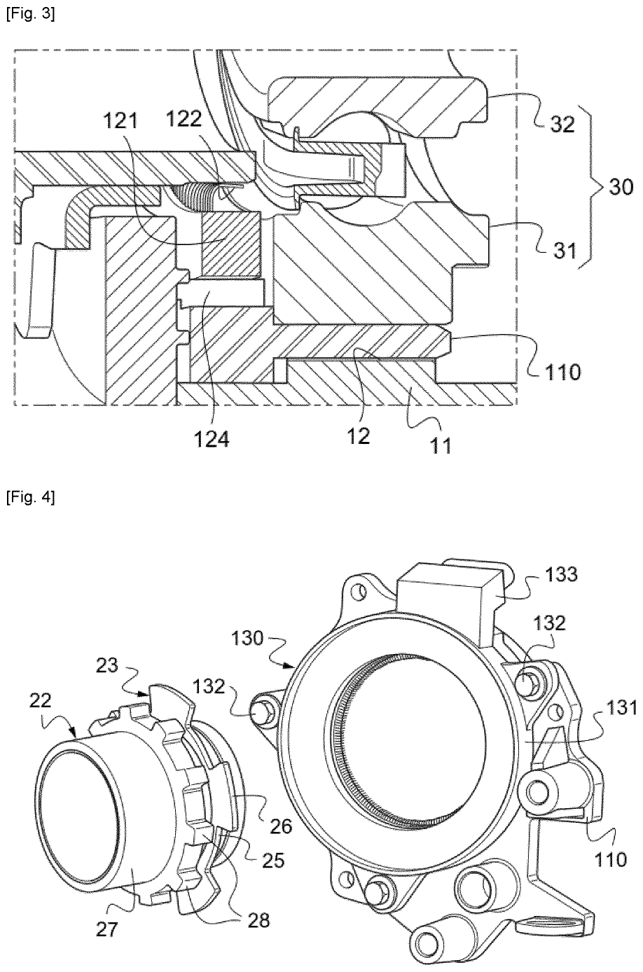

FIG. 3 is a sectional view of a detail of the electric machine in FIG. 1;

FIG. 4 is a schematic exploded view, in of the annular support, of the position sensor, of the toothed wheel and of the target of the electric machine in FIG. 1;

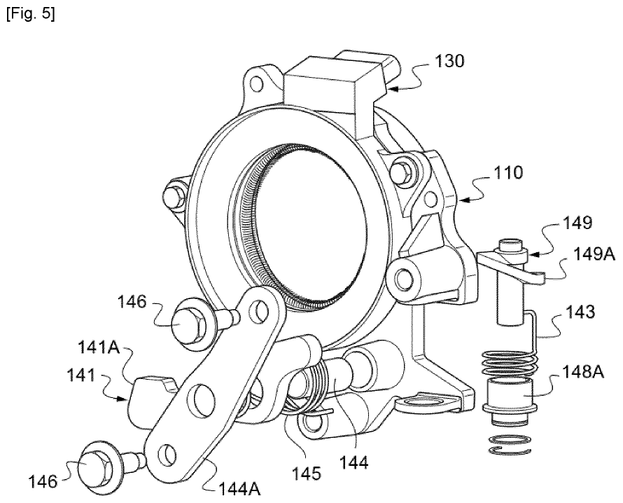

FIG. 5 is a schematic exploded view, in perspective, of a portion of the parking brake device of the electric machine in FIG. 1;

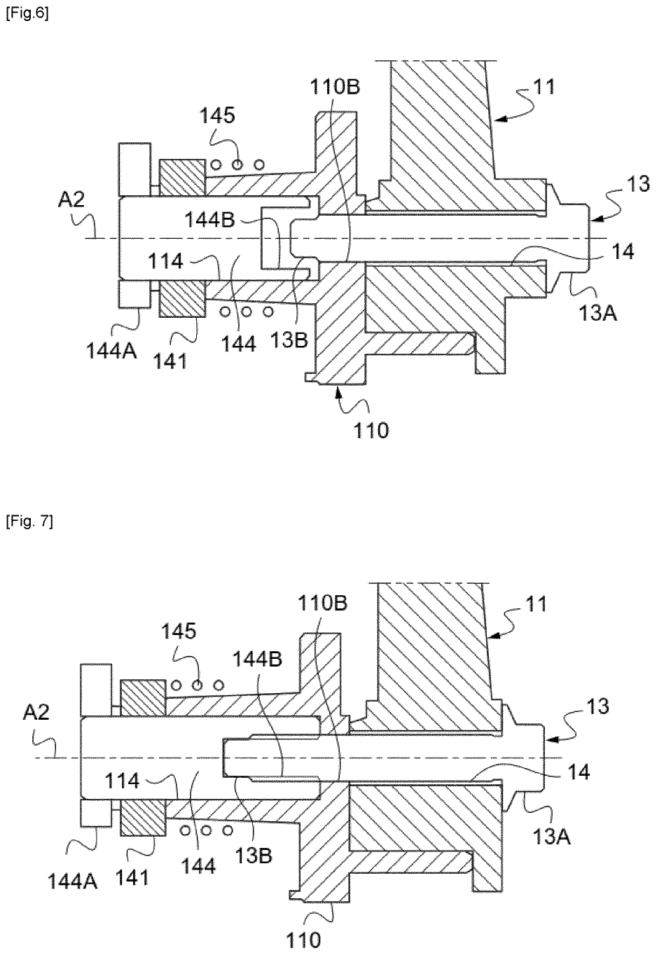

FIG. 6 is a schematic sectional view of a portion of the parking brake device in FIG. 5; and

FIG. 7 is a schematic sectional view of a variant embodiment of the portion of the parking brake device depicted in FIG. 6.

FIG. 1 depicts an electric machine 10 of a motor vehicle.

This motor vehicle may be of any type. It is, for example, a car which conventionally comprises a chassis and wheels.

This car comprises an electric or hybrid motor. It is thus equipped with at least one electric machine which serves as a traction motor for driving the driven wheels. This electric machine is preferably coupled to the driven wheels by a reduction gear and a differential. This coupling is preferably continuous in the sense that it is not possible to uncouple the driven wheels from the electric machine.

Conventionally, the electric machine 10 has an outer Casing which is produced in multiple parts assembled to delimit a chamber which receives a rotor 20 and an annular stator.

This electric machine could be of any type: with axial flux or radial flux, with a wound rotor or otherwise, etc.

The stator is fixed to the casing whereas the rotor 20 is intended to pivot in the stator and the casing.

The rotor 20 has a central opening via which it is fixedly mounted on a rotary shaft 21, which thus forms the output shaft of the electric machine 10.

Conventionally, this rotary shaft 21 is mounted in the casing so as to be able to rotate relative thereto about an axis of rotation A1.

For this, it is equipped, close to its ends, with two rolling bearings 30, just one of which is depicted here and will be described hereinafter (the other being arranged as standard in an opening in the casing).

This rolling bearing is a ball bearing, the inner race of which is shrink-fitted onto the rotary shaft 21 and the outer race of which is placed in an opening provided to this end in the casing. As a result, the rotary shaft 21 is rotationally guided about its axis of rotation A1.

It will be noted here that the outer race of the rolling bearing 30 is not directly fixed in the opening in the casing but an intermediate part inserted between them is provided. This intermediate part, which thus acts as a “fitted bearing”, will be referred to as “annular support 110” hereinafter.

The rotary shaft 21 has, at its free end and beyond the rolling bearing 30 and outside of the casing, a pinion 24 for coupling it to the driven wheels of the motor vehicle.

The electric machine 10 incorporates in this case, within its casing, a parking brake device 100 which notably has this annular support 110.

According to the invention, this parking brake device 100 is multifunctional in the sense that it provides a parking brake function, but also at least one other function. The annular support 110 is then specially designed to bear the components that are able to provide all these various functions.

A first function of the device is thus a brake function for preventing any rotation of the rotary shaft 21 relative to the casing. A second one of its functions is a function of grounding the rotary shaft 21. A third one of its functions is a function of measuring the angular position and/or speed of the rotary shaft 21.

While the first function is compulsory, in one variant it would be possible to provide that the parking brake device 100 provides only one or the other of the second and third functions.

The components borne by the annular support 110 for providing the first function, that of a parking brake, are designed to act directly on the rotary shaft 21 of the electric machine 10 in order to brake the vehicle when the latter is parked. This rotary shaft 21 bears a toothed wheel 22 to this end.

In an electric or hybrid vehicle as defined above, the electric machine 10 actually always remains coupled to the driven wheels f the vehicle, because neither a clutch nor a gearbox is provided between the electric machine 1 and the driven wheels. By contrast, a simple reduction gear (typically with a single constant take-off ratio) is provided. Therefore, immobilizing the rotary shaft 21 of the electric machine 10 makes it possible to immobilize the driven wheels, and thus provide high-performance parking braking.

In this regard, it may be noted that, if a torque is applied to the wheels, the torque experienced at the rotary shaft 21 will be reduced by the reduction gear, and so it will be less demanding to brake the vehicle at the rotary shaft 21 than at the wheels.

In this case, the parking brake device 100 is placed around the rotary shaft 21. The toothed wheel 22 which can be pressed against to mechanically realize the braking is for its part located between the rotor 20 and the rolling bearing 30, inside the casing. It is thus especially lacking in bulkiness.

A more detailed description will now be given of the annular support 110 and the components of the parking brake device 100 that make it possible to provide the three aforementioned functions.

The annular support 110 is depicted in detail in FIG. 2.

As FIG. 3 shows, it is thus installed in an opening 12 in the casing 11, so as to be inserted between the edge of this opening 12 and the exterior face of the outer race 31 of the rolling bearing 30. It will be recalled at this juncture that the inner race 32 of this rolling bearing 30 is for its part directly shrink-fitted onto the rotary shaft 21.

The annular support 110 is a one-piece part made by casting. It is preferably made from gray cast iron (for example of GL04S type) , this giving it good lubricating, electrically conductive and damping properties for a low cost.

It Thus Forms an Interface of High Stiffness between the rolling bearing 30 and the casing 11, thereby making it possible to reduce the noise generated by the rotation of the rotary shaft 21.

Specifically, it is made from a material which has a stiffness greater than that of the material of the casing 11. Moreover, because it is present, the opening 12 in the casing 11 has a diameter greater than it would have needed to have in the absence of an annular support 110, such that the casing 11 itself has a stiffness greater than it would have had in the absence of an annular support 110. In this way, the rotary shaft 21 is better guided, better damped and vibrates less, thereby reducing stresses and noise.

As shown in FIG. 2, this annular support 110 has a first portion 111 which is inserted between the rolling bearing 30 and the casing 11, and a second portion 112, facing the rotor 20, to which the components that provide the three aforementioned functions can be fixed.

The first portion 111 has the form of a ring, with an inner face, which is a cylinder of revolution, shrink-fitted onto the outer race of the rolling bearing 30, and an outer face, which is a cylinder of revolution, shrink-fitted into the opening 12. These shrink-fitting operations can be implemented by pressing.

The second portion 112 forms a sort of flange extending in a plane orthogonal to this axis of rotation A1, on one side of the first portion 111. It has tapped bores and tapped wells along axes parallel to the axis of rotation A1, thereby making it possible to attach there the components providing the three aforementioned functions.

FIG. 2 also depicts the electrical conduction means 120 which make it possible to electrically connect the rotary shaft 21 to the casing 11 in order that this shaft does not become charged with electrical current and generate destructive electrical arcs in the rolling

These means are thus designed to ground this rotary shaft 21. They are moreover positioned as close to the rolling bearing 30 as possible to give it maximum protection.

They could take various forms, and typically are in the form of a felt with integrated metal wires.

In this case, the means are a grounding ring, of the type comprising curved wires around the circumference.

It thus has a ring body 121 which is provided to be immobilized in position on the annular support 110, and flexible electrical conduction elements 122 provided to press against the rotary shaft 21 or, as is the case here, against an element fixed to this shaft, i.e. against the toothed wheel 22.

The flexible electrical conduction elements 122 are in this case curved metal wires extending all around the axis of rotation A1 in order to have good electrical conductivity as a whole.

As FIG. 3 shows, the ring body 121 is provided to press directly against one side of the outer race 31 of the rolling bearing 30, which is that facing the inside of the casing 11.

It has an outside diameter slightly greater than or equal to the inside diameter of the annular support 110, so as to ensure electrical contact from the rotary shaft 21 to the casing 11 via this annular support 110, and it will be recalled that the latter is made of cast iron, giving it good electrical conduction properties.

The flexible electrical conduction elements 122 are provided protruding toward the inside of the ring body 121 such that their ends extend around a circle of a diameter smaller than the diameter of that portion of the toothed wheel 22 against which they press.

The mounting of this grounding ring directly on the annular support 110 reduces the risks of misalignment and thus the risks of breakage of the curved wires.

FIG. 3 shows that a groove 124 is made in the inner face of the annular support 110, at this ring 121, so as to form a space between the ring 121 and the annular support 110 via which oil can flow toward the bottom of the casing 11. This groove 124 thus makes it possible to reduce the risks of oil being splashed on the rolling bearing 30 and to limit the amount of oil on the rotary shaft 21 (reducing the electrical conductivity of the latter).

FIG. 4 depicts measurement means 130 for measuring the angular position and/or speed of the rotary shaft 21.

These measurement means, in practice and in this case, comprise an inductive position sensor designed to determine the position of a target washer 23 fixed to the rotary shaft 21.

This target washer 23 has an annular body 25 mounted directly on the rotary shaft 21 or, as is the case here, on an element fixed to this shaft, specifically on the toothed wheel 22.

It also has tabs 26 protruding outward from the annular body 25, which are evenly distributed around the axis of rotation A1.

The target washer 23 is angularly indexed on the rotary shaft 21, such that the computer for controlling the electric machine knows its exact angular position.

The inductive position sensor, for its part, has an annular body 131 with inside and outside diameters substantially equal to those of the annular support 110. It also has three radially outwardly protruding lugs for fixing it to the annular support 110, in this case by screwing. Three screws 132 are utilized here in this regard.

The fixing of this inductive position sensor directly to the annular support 110 makes it possible to ensure correct centering of this sensor relative to the axis of rotation A1. As a result, these measurement means 130 are designed to determine the angular position of the rotary shaft 21 with a precision of about one tenth of a degree.

It will be noted that this sensor, once it is fixed, makes it possible to immobilize the grounding ring against the rolling bearing 30 in order to axially immobilize it (see FIG. 3).

The inductive position sensor lastly has a radial widening 133 protruding outward from the annular body 131 and receiving data communication means connected to the computer for controlling the electric machine 10. In this case, to this end this radial widening 133 has a terminal for wiring it up to the computer.

As FIGS. 1 and 5 show, to perform the desired braking, specifically in this case complete immobilization of the rotary shaft 21 relative to the casing 11, the parking brake mechanism 140 comprises:
a catching means 141 for catching on the toothed wheel 22, which it will be recalled is fixed to the rotary shaft 21, and
an actuator 142 designed to move the catching means 141 between a position caught on the toothed wheel 22 and a position not caught on the toothed wheel 22.

As FIG. 4 shows, the toothed wheel 22 has a tubular body 27 and, protruding from the outer face of this tubular body 27, at least one relief. It has several reliefs in this case that form dogs 28. The dogs 28 have identical forms and are evenly distributed around the circumference of the tubular body 27 of the toothed wheel 22. They thus delimit crenelations of which the lateral faces extend radially in relation to the axis of rotation A1.

These dogs 28 are in this case located halfway along the tubular body 27 and thus extend at a distance from the ends of this body. As a result, the tubular body 27 has a length such that it makes it possible to stiffen the rotary shaft 21 onto which it is shrink-fitted.

The target washer 23 is then mounted on the tubular body 27 of this toothed wheel 22, on the rolling bearing 30 side. The wires of the grounding ring also press against this side of the tubular body 27.

The catching means 141 of the parking brake mechanism 140 could take various forms.

As FIG. 5 shows, in this case it takes the form of a lever 141 of which one end is shaped to engage between two dogs of the toothed wheel 22 in order to prevent any rotational movement of the rotary shaft 21. This end of the lever 141 for this purpose bears a tooth 141A which has an identical, negative shape with respect to the space between two dogs of the toothed wheel 22.

Halfway along this lever 141 there is an opening 141B via which it is mounted so as to be able to rock on the annular support 110.

In practice, to ensure this mobility, a pin 144 is fixed on a first side of the annular support 110 and it receives at its opposite end the lever 141, which is freely rotationally mounted on this end of the pin 144.

This pin 144 is preferably substantially a cylinder of revolution about a central axis A2 parallel to the axis of rotation A1, which central axis A2 forms the axis of articulation of the lever 141. It is in this case shrink-fitted by way of its first side into a recess 114 delimited by a well protruding from the second portion 112 in the form of a flange of the annular support 110 (this shrink-fit mounting is possible because the assembly formed of the annular support 110 and of the components that it supports can be assembled outside of the casing 11). The opening 141B in the lever 141 is for its part engaged on this pin 144 such that the lever 141 presses on one side against the free end of the well which receives the pin 144.

The lever 141 is thus mounted on the annular support 110 with a single degree of freedom, i.e. an ability to pivot about an axis strictly parallel to the axis of rotation A1, between two end positions referred to as caught position (in which the tooth 141A is received between two dogs) and uncaught position (in which the tooth is at a distance from the dogs).

In a variant, it would be possible for the pin 144 to not be a cylinder of revolution or to be a cylinder of revolution only over one portion of its length. Typically, on another portion of its length it could have a flattening which makes it easier to prevent it from rotating on the annular support 110.

It will be understood that, when the lever 141 prevents the rotation of the rotary shaft 21 and the vehicle is stationary on a slope, considerable forces act on the pin 144.

Consequently, to avoid the pin being deflected and the lever 141 being permitted to come out of the toothed wheel 22, means for fixing the free end of this pin 144 in place are provided. These means in this case take the form of a plate 144A with an opening in its center to receive the free end of this pin 144 and at its ends to allow it to be fixed, in this case by means of screws 146, to the annular support 110. This plate 144A also makes it possible to prevent the lever 141 sliding along the central axis A2.

To reduce the friction between this plate 144A and the lever 141 when the latter rocks, it is possible to provide a washer inserted between these two elements.

At its end opposite to the tooth 141A, the lever 141 has a bearing end on which the actuator 142 can exert a force to cause it to rock.

When it is activated, the actuator 142 is in this Case provided to force this lever 141 to move toward one of the two aforementioned positions. Elastic return means 145 are provided to bring it toward the other of these two positions when the actuator is inactive. These elastic return means 145 are in this case formed by a torsion spring threaded onto the pin 144, between the annular support 110 and the lever 141, such that one of its ends presses against the annular support 110 and another of its ends presses against the lever 141.

In practice, the actuator is provided to force the lever to rock into the caught position.

It would be possible to use any type of actuator, for example an electric servomotor, an electromagnetic system with a movable magnet, etc.

As FIG. 1 shows, this actuator 142 in this case comprises a support 147 fixed to the casing 20 (inside the latter) and a sliding arm 148 designed to slide relative to the support 147 toward a deployed position when it is activated, and to return to the initial position otherwise.

If the angular position of the rotor 20 can be controlled with great precision, the catching of the toothed wheel 22 will be made easier and will thus allow the use of a lower-power actuator 142 (which is not very bulky or expensive).

If this is the case, it would be possible to provide that the actuator 142 is connected to the lever 141 via a simple link rod or that it presses directly against the lever.

However, as a safety measure, preference will be given to providing elastic connection means 143 between the actuator 142 and the lever 141, such that if the lever 141 is immobilized by the toothed wheel 22 (because its tooth does not exactly face a space delimited by dogs), these elastic connection means allow the actuator to make the sliding arm 148 slide without damage and without forcing.

In practice, as FIG. 5 shows, provided at the end of the sliding arm 148 in this case is a cap 148A which is fixed thereto and which bears, as elastic connecting means 143, a torsion spring. This cap 148A also bears a shaft 149.

This shaft 149 is mounted so as to be able to pivot in the cap 148A about the axis of the sliding arm 148. It bears a cam 149A which forms a slope which is inclined relative to this axis and presses underneath the free end of the lever.

As a result, the sliding movement of the sliding arm 148 can force the lever to rock, but if the lever is immobilized, the shaft 149 will be able to pivot by virtue of the cam 149A and avoid any damage to the mechanism. The torsion spring 143 will for its part make it possible to bring the shaft 149 into the initial position as soon as this is possible.

FIG. 1 illustrates three fixing screws 13 provided to fix the annular support 110 to the casing 11 (not depicted in this figure).

These fixing screws 13 conventionally have a head which bears a recess to make it easier to control, and a partially threaded body.

These fixing screws 13 are provided to be engaged through holes made in the casing, from the outside thereof, in order to be screwed into the annular support 110 or into a part fixed to the latter. The annular support 110 then to this end has three holes, preferably through-holes parallel to the axis of rotation A1, which might be tapped. These three holes are in this case evenly distributed about the axis of rotation A1 at 120° in relation to one another and are formed in lugs radially protruding from the edge of the annular support 110.

According to the invention, as shown in FIG. 6, one of these fixing screws 13 is located such that it passes through the central axis A2 of the pin 144. This fixing screw 13, which will be the one under consideration in the rest of this description, is in this case oriented such that its screwing axis is parallel to this central axis A2. The screwing axis of this fixing screw 13 preferably coincides with the central axis A2 of the pin 144.

In a variant, the fixing screw 13 could be offset from the central axis A2 by a few millimeters at most. In another variant, it could be inclined relative to the axis.

So as to not lock the screwing of this fixing screw 13, one of the ends of the pin 144 then preferably has a cavity 144B made in it which faces the free end 13B of the fixing screw 13.

FIGS. 6 and 7 depict two variant embodiments of the fixing of the fixing screw 13.

In these figures, elements that are similar are provided with the same reference signs, and only their differences will be described.

In these two variant embodiments, the pin 144 is thus prevented from rotating relative to the annular support 110 about the central axis A2. The lever 141 is then mounted with a clearance on this pin so as to be able to freely rotate relative thereto about the central axis A2.

In the embodiment in FIG. 6, the cavity 144B formed at the end of the pin 144 has a diameter strictly greater than the diameter of the fixing screw 13 at its free end 13B. As a result, the fixing screw 13 can freely rotate in this cavity.

The fixing screw 13 then passes through the hole 14 correspondingly provided in the casing 11 and is screwed into a tapped bore 110B provided in the annular support 110, in the axis of the bottom of the recess 114 for receiving the pin 144. Once it is screwed, its head presses against the outer face of the casing 11.

As a result, the forces that act on the pin 144 are properly transferred to the annular support and then to the casing 11, via the fixing screw 13.

In the variant embodiment which is illustrated in FIG. 7 and preferred to the embodiment illustrated in FIG. 6, the hole 110B provided in the annular support 110 is not tapped and it has a diameter slightly greater than that of the threaded body of the fixing screw 13, and so these two elements do not cooperate with one another.

However, the Cavity 144B formed at the end of the pin 144 forms a tapped through-bore, in which the fixing screw 13 is screwed. As a result, this screw makes it possible to clamp the pin 144 against the annular support 110 and the annular support 110 against the casing 11.

In this variant embodiment, there is therefore no break in stiffness between the pin 144 and the casing 11. Therefore, the aforementioned components make it possible to better withstand the mechanical stresses exerted on them and they can thus be dimensioned as a result with less bulkiness and at lower cost.

At this juncture, it may be noted that, conventionally, a dielectric lubricant is used to lubricate the rolling bearings 30. This lubricant will naturally provide lubrication for the junction between the lever 141 and its pin 144, and this will ensure the parking brake device operates correctly and has a lengthy service life.

It will also be noted that when the vehicle is stationary on a slope and the parking brake device 100 is activated, it can prove difficult to move this device into the inactive position owing to the forces acting on it.

Consequently, to make the lever easier to move, the electric machine 10 can be operated in such a way as to make the rotary lever 21 rotate through a small travel (of about 1 degree) and in a fairly short timeframe during which the stresses applied to the device will be reduced.

More generally, it will be possible, prior to each deactivation of the parking brake device 100, to make the rotary shaft 21 pivot in one direction and then in the other, in order to ensure that the lever can shortly return to the uncaught position without difficulty.

1-10. (canceled)

11. A parking brake device for being installed in a casing of an electric machine which receives a rotary shaft and at least one rolling bearing for guiding said rotary shaft, said parking brake device comprising:
an annular support which is configured to be inserted between said rolling bearing and said casing and which bears:
a parking brake mechanism configured to prevent rotation of the rotary shaft relative to the casing, and
measurement means to measure an angular position or speed of the rotary shaft relative to the casing, and/or electrical conduction means to route the electrical current between the rotary shaft and the casing.

12. The parking brake device as claimed in claim 11, wherein the annular support bears the measurement means and the electrical conduction means, and said electrical conduction means are configured to be interposed between the rolling bearing and the measurement means.

13. The parking brake device as claimed in claim 11, wherein the parking brake mechanism comprises means for catching on a toothed wheel fixed to said rotary shaft, and an actuator configured to move the catching means between a position caught on the toothed wheel and a position not caught on the toothed wheel.

14. The parking brake device as claimed in claim 13,
wherein the annular support bears the measurement means and the electrical conduction means, and said electrical conduction means are configured to be interposed between the rolling bearing and the measurement means, and
wherein the electrical conduction means have a ring fixed to the annular support and flexible electrical conduction elements which press against one portion of the toothed wheel.

15. The parking brake device as claimed in claim 13, wherein an elastically deformable portion is provided between the actuator and the catching means and is configured to allow the actuator to move when the catching means is immobilized by the toothed wheel.

16. The parking brake device as claimed in claim 11, wherein the measurement means comprise a position sensor configured to determine the position of a washer fixed to the rotary shaft.

17. The parking brake device as claimed in claim 11, wherein the annular support is formed of a single one-piece part.

18. The parking brake device as claimed in claim 11, wherein the annular support is formed of a single one-piece part and is made at least partially of cast iron.

19. The parking brake device as claimed in claim 11, wherein the annular support delimits an inner face of which a portion which is a cylinder of revolution receives said rolling bearing, and an outer face of which a portion which is a cylinder of revolution is configured to be installed in an opening in the casing.

20. An electric machine comprising:
a casing;
a rotor received in the casing;
a rotary shaft fixed to the rotor and pivotably mounted in the casing via at least one rolling bearing; and
the parking brake device as claimed in claim 11.

21. A motor vehicle comprising:
a chassis;
wheels coupled to the chassis; and
the electric machine as claimed in claim 20, wherein the rotary shaft is coupled to at least some of said wheels.
